(19) United States
(12) Patent Application Publication
(10) Pub. No.: US 2002/0144010 A1
(43) Pub. Date: Oct. 3, 2002

(54) Communication handling in integrated modular avionics

(75) Inventors: Mohamed Younis, Columbia, MD (US); Mohamed Said Aboutabl, East Stroudsburg, PA (US)

Correspondence Address: Loria B. Yeadon, Honeywell International Inc., 101 Columbia Road, Morristown, NJ, 07962, US

(73) Assignee: Honeywell International Inc.

(21) Appl. No.: 09/821,601

(22) Filed: Mar. 29, 2001

Related U.S. Application Data
(60) Provisional application No. 60/202,984, filed on May 9, 2000.

(51) Int. Cl. G06F 9/46; G06F 9/00

(52) U.S. Cl. 709/314; 709/103

(57) ABSTRACT

Techniques for inter-application communication and handling of I/O devices in an Integrated Modular Avionics (IMA) system enable the integration of multiple applications while maintaining strong spatial and temporal partitioning between application software modules or partitioned applications. The integration of application modules is simplified by abstracting the desired application interactions in a manner similar to device access. Such abstraction facilitates the integration of previously developed applications as well as new applications. The invention requires the least support from the operating system and minimizes the dependency of the integrated environment on application characteristics.

### PRIORITY CLAIM

This invention claims priority to United States provisional application Serial No. 60/202,984 filed May 9, 2000.

### RELATED APPLICATION

This application is related to M. S. Aboutabl and M. Younis'application Ser. No. 09/648,985, filed Aug. 20, 2000, entitled “An Approach for Supporting partitioning and Reuse in Intelligent Modular Avionics”.

### FIELD OF INVENTION

This invention relates to communication between software applications and the handling of input/output (I/O) devices for avionics equipment.

### BACKGROUND OF THE INVENTION

Recent advances in computer technology have encouraged the avionics industry to take advantage of the increased processing and communication power of modem hardware and combine multiple federated avionics applications into a shared platform. A new concept, called Integrated Modular Avionics (IMA) has been developed for integrating multiple software components into a single shared computing environment powerful enough to meet the computing demands of these traditionally separated components. This integration has the advantage of lower hardware costs and a reduced number of spare units that need to be held by the airline operators. Reductions in weight and power consumption of an aircraft's avionics equipment can be achieved by this integrated approach.

The IMA approach also brings new problems and issues. Chief among these is the problem of avoiding unwanted dependencies between applications. It is necessary to be able to show, with a very high level of assurance, that a problem or failure in one application cannot have an adverse impact on any other application. Without a high level of assurance the aircraft certification authorities (e.g. the FAA) will be unwilling to certify the installation of such systems on an aircraft. Therefore, it is required for IMA-based applications to be strongly partitioned both spatially and temporally.

Strong or robust partitioning conceptually means that the boundaries among applications are well defined and protected so that operations of an application module will not be disrupted nor corrupted by behavior of another, even if the other application is operating in an erroneous or malicious way. Containing the effects of faults is very crucial for the integrated environment to guarantee that a faulty component cannot cause other components to fail and risk generating a total system failure. For instance, in an ideal IMA-based avionics system, a failure in the cabin's temperature control system must not negatively influence critical flight control systems required for safe operation of the aircraft.

In a federated avionics system, applications do not share processors or communications hardware with each other and partitioning comes naturally, but the cost is high because of the exclusive use of computing resources. In an IMA environment, an application will frequently share a resource with other applications and thus its correct operation becomes dependent on the correct sharing of the resource. When multiple avionics software application coexist on the same computer, partitioning is particularly challenged in the way applications access memory, consume CPU processing cycles and interface with input and output devices. Usually applications are allocated different memory regions while the usage of shared resources such as the CPU and I/O devices are arbitrated among them based on a time schedule. The memory partitioning and time schedules are usually determined as part of the integration of the applications into a system—and before the system is used on an aircraft.

Although dividing memory and resource capacity among several applications forms boundaries and facilitates the integration, it cannot guarantee that those boundaries will not be violated under some conditions when faults exist. Therefore, the IMA environment needs to ensure strong partitioning among the integrated applications both spatially and temporally. The address space of each application must be protected against unauthorized access by other applications. In addition, an application should not be allowed to over-run its allocated quota of CPU time usage and delay the progress of other integrated applications.

Strong or robust partitioning implies that any erroneous behavior of a faulty application partition must not affect other healthy applications. The erroneous behavior of an application can be the result of a software fault or a failure in a hardware device used exclusively by that application. The fault can be generic, accidental or intentional in nature; it can be permanent, transient or intermittent in duration. It is useful to implement application-specific semantic checks, which verify the validity of the communicated data to detect errors due semantic-related generic faults in the application software. Usually, the system is not liable to Byzantine faults, i.e. all faults manifest themselves into errors, which are detected in the same way by all the other healthy modules. Additionally, faults usually occur one at a time with no simultaneity.

An attempt by a faulty component to corrupt other healthy system components should lead to a detected error. Only applications that communicate with that faulty application partition need to be aware of the error and perform recovery actions according to the nature of the application. On the other hand, operations of healthy applications that do not communicate with the faulty application will not be affected.

### SUMMARY OF THE INVENTION

The present invention discloses novel techniques for inter-application communication and handling of I/O devices that facilitate integration of applications in an IMA system. These techniques enable the integration of multiple applications while maintaining strong spatial partitioning between application modules. Integration of application modules is simplified by abstracting the desired interactions among the applications as device access transactions. Such abstraction facilitates the integration of previously developed application in the IMA environment. The approach requires less support from the operating system than other approaches and minimizes the dependency of the integrated environment on details of the applications. Thus, this invention focuses on ensuring spatial partitioning while enabling communication and device sharing, among the integrated applications.

The present invention comprises methods and apparatus for inter-application communication and handling of I/O devices that facilitate integration of applications in an EMA system which comply with the ARINC specification 653. The present invention enables the integration of multiple applications while maintaining strong spatial and temporal partitioning between applications. The present invention simplifies integration of these application modules by abstracting interactions among the applications as device access transactions using an inter-partition messaging service which can be abstracted to the application tasks within a partitioned application as a device driver.

### DESCRIPTION OF THE DRAWINGS

FIG. 1 is a diagram depicting the two layer operating environment that may be employed by our invention.

FIG. 2 depicts the client-server inter-partition message passing protocol in accordance with our invention.

FIG. 3 depicts the registry table of Inter partition Communication (IPC) channels.

FIG. 4 illustrates the access to the IPC queue developed in accordance with the present invention.

FIG. 5 illustrates the circular queue developed in accordance with the present invention.

FIG. 6 is a table of commands for a send algorithm of the present invention developed in accordance with the present invention.

FIG. 7 is a table of commands for a receive algorithm developed in accordance with the present invention.

FIG. 8 illustrates the broadcasting stream buffer at the present invention developed in accordance with the present invention.

FIG. 9 depicts the handling of output devices developed in accordance with the present invention.

### DETAILED DESCRIPTION

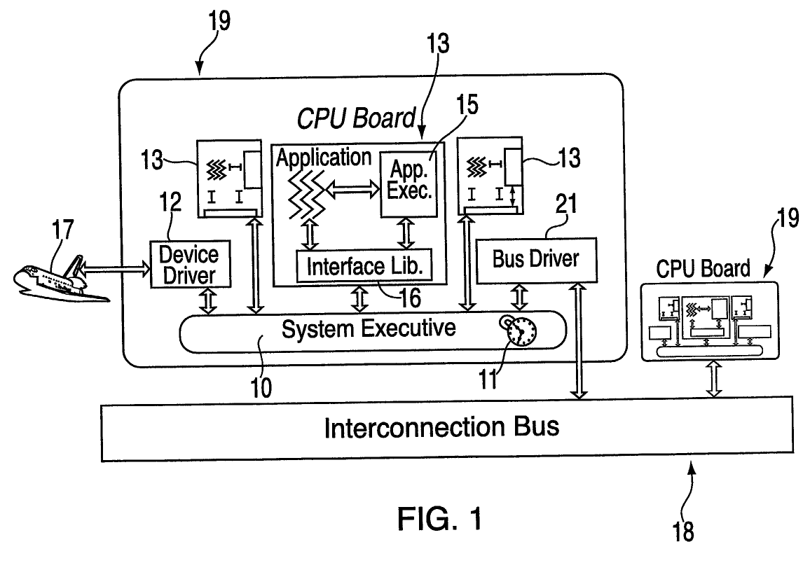

FIG. 1 shows an architecture for integrating real-time safety-critical avionics applications, as described in Aboutabl-Younis application Ser. No. 648,985, filed Aug. 20, 2000, and which may be used in our present invention. The architecture, depicted in FIG. 1, is fundamentally a two-layer operating environment that is able to comply with the ARINC specification 653 and the Minimum Operational performance Standards for Avionics Computer Resource. However, the present invention goes further by enabling the integration of legacy software modules together with their choice of real-time operating system, all executing on a shared CPU. Although the discussion of our approach for inter-application communication refers to this architecture, the techniques are also applicable to other IMA systems.

The bottom layer of the architecture, termed the System Executive (SE) 10, provides each application module 13 with a virtual machine, i.e. a protected partition, inside which the application can execute. In this way, the application is isolated from other applications in the space domain. We rely on hardware means such as a memory management unit (not shown) which is available with most modem processors to enforce spatial partitioning. Time-domain isolation is accomplished by sharing CPU board 19 and other resources among applications based on a pre-computed static timetable. The system 10 executive maintains a real-time clock 11 to strictly implement the timetable in which each application is assigned well-defined time slices. In addition to ensuring spatial and temporal partitioning, the SE 10 handles context switching, and initializes/monitors/terminates application partition 13. Only the SE 10 would have the ability to execute in the highest privileged CPU mode. All other partitions execute in a less privileged CPU mode thus ruling out the possibility of an application corrupting the memory protection set up or violating other applications' rights to use the CPU 19. Each CPU 19 also includes a device driver 12 which communicates with external devices, such as a keyboard or computer located on an airplane 17 and a bus driver 21 which provides communication with the interconnection data bus 18.

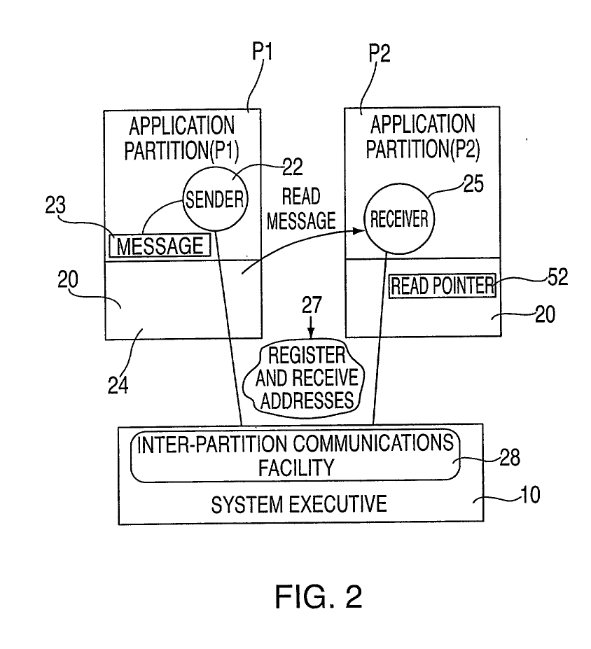

Each partitioned application 13, which may consist of multiple tasks, is assigned a protected memory partition for example, P1 in FIG. 2, thus preventing a fault in one application partition from propagating to other applications. To accomplish this feature, each application 13 is accompanied by its own Application Executive (AE) 15 as well as an Interface Library (IL) 16 to the System Executive (SE) 10. The AE 15 handles intra-application communication and synchronization. The AE 15 also manages the dynamic memory requirements of the application within the boundaries of the application's own memory partition. The AE 15 may also implement its own strategy for scheduling the application's tasks. All of the Application Executive's (AE) 15 functions related to inter-application and inter-processor communications are handed through the Interface Library 16 to the SE 10.

Since operating systems in general assume privileged access to the hardware, the System Executive 10 needs to provide services to the application executives 15 that enable them to handle privileged operations. These services include exception handling, interrupt enabling and disabling and access to processor internal state, e.g., during thread context switching. The Interface Library (IL) 16 encapsulates these services. The IL acts as a gateway between the Application Executive 15 and the computer's hardware services.

The main design goal for the two-layer architecture is to keep the SE 10 simple and independent of the number and type of integrated applications. Simplicity of the SE 10 design facilitates the certification. Being independent of the integrated applications 13 makes the SE 10 insensitive to changes to the applications and thus limits re-certification efforts to application changes or upgrades. The inter-application communication paradigm is one major aspect that determines the degree of coupling between the SE 10 and the individual application partitions. Therefore, the mechanism for inter-application communication should avoid coupling the SE 10 with the application to the greatest extent possible. The following description discusses our approach for inter-application communication that maintains strong partitioning between integrated applications, allows communications and does not involve the SE. Throughout this discussion, the terms partition and application are used interchangeably. It should be noted that the presented approach fits any two-layer IMA software architecture not only the one discussed herein.

Communication primitives are needed to share data among the various partitions. Generally, message passing and shared memory are used for inter-task communication in a multi-task setup. The same techniques are applicable to inter-partition communication. However, our approach only supports the use of message passing as a means for inter-partition communication (IPC) in an IMA environment. The support for shared memory IPC complicates the memory management. The system executive needs to allocate memory areas, either in the SE 10 address space or in a globally accessible memory area, to host the shared data. Access to these shared data has to be through SE 10 services. The SE 10 needs to manage the shared memory to maintain consistency of the data while context switching among partitions. Although shared memory is doable, it contributes to the complexity of the SE 10. In addition, shared memory is prone to error propagation since minimal checks are usually deployed to validate the data. On the other hand, message passing is able to provide a robust communication means among partitions. Rigorous message format checking can be imposed to guard against bogus traffic. In addition the ARINC 653 standard for the application executive interface (APEX) in IMA environment and the RTCA minimum operational performance standards for Avionics Computer Resource (ACR) also call for the use of message passing for IPC. It should be noted that application tasks within a partition may still communicate with each other through the application developer's mechanism of choice. Only communication activities from one partition to another are required to be through message passing.

In accordance with our invention, application 13 is split between application partitions P1 and P2, which communicate to share data and services, as seen in FIG. 2. If a partition P1 needs data from another partition P2, P1 either sends an explicit request to P2 to obtain the data or expects P2 to continuously make the data accessible to P1. Sharing services often requires exchange of request and response messages between the requester (client) and the service provider (server). In our approach, we classify messages according to the communication semantics into request-response (client-server) messages and status messages. In client-server IPC, we allow only one server to receive requests from possibly multiple clients. Implementation of status messages is simplified by posting the messages and making them readable to designated partitions. The following explains how client-server and status messages among partition are supported.

One possible approach to support client-server message-passing IPC within our environment is to allocate a message queue to be shareable among the communicating partitions. Although this approach maintains the robustness advantage of message passing, it implicitly requires supporting shared memory IPC as the means to write and read messages from the queue and thus leads to an increased complexity of the SE design as discussed earlier.

However, in accordance with our invention, a different approach is taken, which approach, as shown in FIG. 2 requires a sender partition 22 to allocate a message queue 24 in its own memory space 20 for a sender message 23. The sender partition either makes the queue 24 readable to the receiver partition 25 or relies on the SE 10 to copy messages from the sender's address space (not shown) to a message queue (not shown) in the receiver's address space.

Copying messages from the sender 22 to the receiver partition 25 requires that a comprehensive message handler be included in the SE. When the message handler gets a request from a sender partition to insert a message to a receiver queue, the handler physically copies the message to the destination queue after validating the authenticity of such communication. Involving the system executive in handling of inter-application messages increases the coupling between the applications and the SE and thus complicates the integration. In addition, a message-handling library, supported by the SE, significantly contributes to the complexity of the SE design—particularly when dealing with context switching among partitions, interrupts and potential exceptions triggered during message handling.

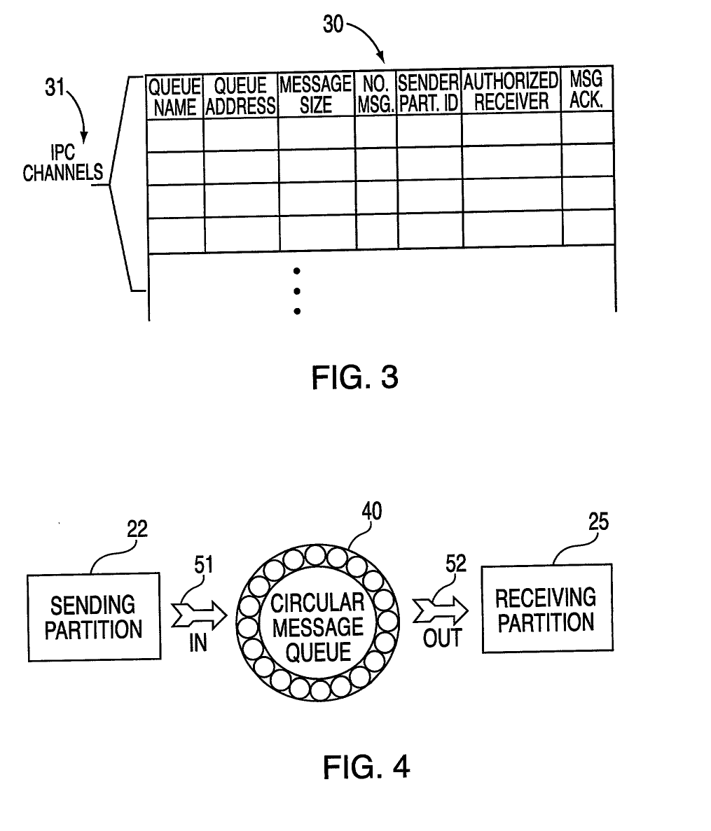

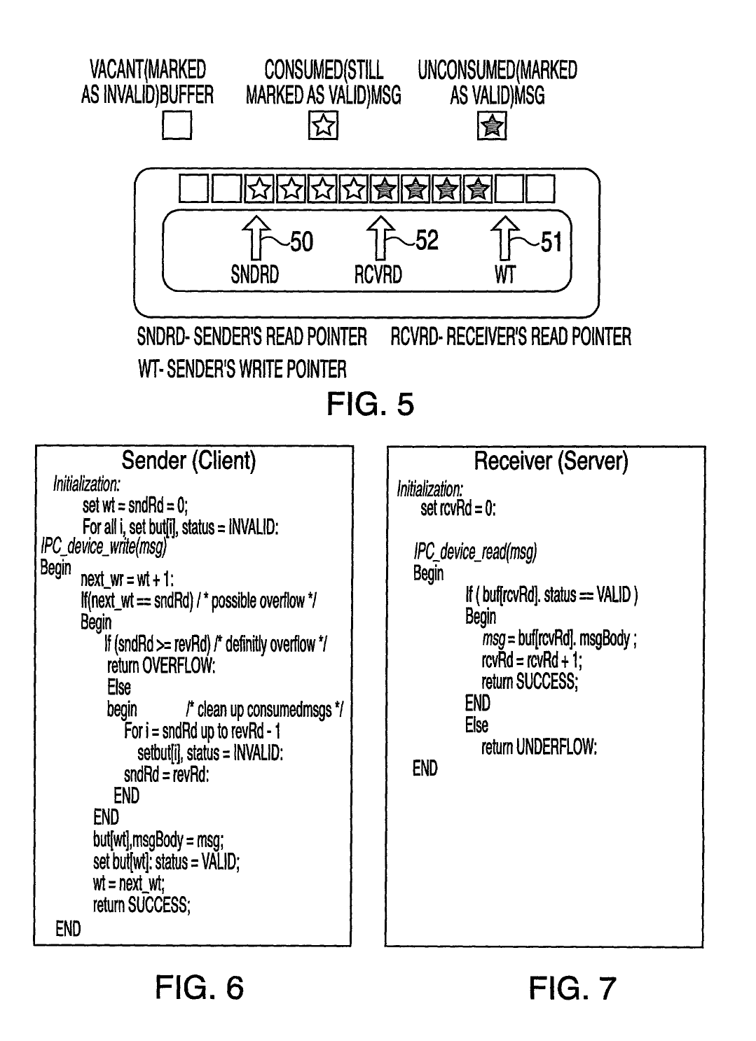

Alternatively, in accordance with another aspect of our invention an allocation involves the use of a circular queue 40 in the sender partition 22 for outgoing messages as shown in FIG. 4. As shown in FIG. 3, the circular queue will be mapped, by the SE 10 using a channel registry table 30, to the address space of an authorized receiver partition 25 for read-only access. The sender partition 22 is the only one that has write access to the circular queue 40. As shown in FIG. 5, the sender partition maintains a read pointer 50 and a write pointer 51 for the circular queue 40. The write pointer 51 will be used to insert new messages. The read pointer 50 is used to detect overflow conditions, as will be explained later. As shown in FIG. 2, the receiver partition 25 will maintain its own read pointer 52 for the queue and will make it readable to the sender partition.

The receiver will use its sender read pointer 50 to access messages from the circular queue 24. As shown in FIG. 5, when the sender partition 22 detects an overflow during message insertion, it removes those messages if any, which the receiver has already consumed. The sender identifies the consumed messages by comparing the value of its version of the read pointer 50 with the value of receiver's read pointer 52. If the sender still experiences an overflow after updating its read pointer 50, an error should be declared and an application-specific action has to be taken. The read receiver pointer 52 of the receiver partition 25 can also be used for acknowledgment, if needed. The sender partition 22 can check the value of the read pointer of the receiver read pointer 52 to ensure that a message (client's request, for example) is being received by the server, receiver partition 25.

The new inter-partition message service can be abstracted to the application tasks within a partition as a device driver. This abstraction is consistent with the specifications of the ARINC 653 standard, which describes communication primitives between the partitions as a whole. Routing the inter-partition messages to component tasks is not handled by this standard. Using the device driver abstraction facilitates the integration of legacy federated applications since they already have a means to communicate over external devices. Since message queue is SE 10 specific, it does not have to change when integrating a new application. In addition, only the device driver for the communication channel used by a federated application needs to be replaced for the integration.

Since the SE 10 is the only component permitted to manage the CPU 19 memory (not shown) in order to ensure spatial partitioning, the sender partition 22 needs to register the queue address 27 with the SE 10. In addition, the receiver partition has to register the location of its receiver read pointer 52 for that queue. The registration can be performed either during system initialization or at link time. In both cases, the SE 10 will maintain a list of the addresses of all IPC-related data structures. Registering the addresses during system's initialization requires invocation of SE's 10 library routines in order to access the SE's 10 address space. After the registration both the sender partitions 22 and receiver partitions 25 should query the list for the addresses of the receiver read pointer and queue respectively.

A sender partition P1, which sends messages to a receiver partition P2, needs to statically define a queue in its own address space to host these messages. The sender partition P1 is required to register that queue partition that is to make an Interpartition Communication (IPC) service 28 within the SE 10 aware of the queue address and of the receiver partition P2 authorized to receive messages from this queue. As shown in FIG. 3, the SE 10 maintains the IPC channel registry table 30 for all open IPC channel 31. The registry table is maintained by the system executive 10 and is accessible for read-only by the partitions.

A pre-defined circular message queue 40 structure (IPC_queue) has to be used in order to unify the handling of the IPC queues. The IPCqueue type requires unique pre-partition queue names to be defined at compile time in order to prevent any erroneous change that might cause inconsistency with the SE's IPC channel registry table 30. As shown in FIG. 4, the queue is accessible using two separate read and write pointers, i.e., the receiver read pointer 52 and the sender write pointer 51. The sender read pointer 50 is used and modified by the receiver partition to retrieve the next message. The sender write pointer is solely used by the sender partition to insert messages.

The write operation is completely local to the sender partition 22. In order to keep track of vacant entries, the sender 22 needs to remove consumed messages so that their entry can be reused. The sender partition 22 maintains its own sender read pointer 50 to prevent overwriting an unread message. To synchronize the value of the two read pointers in the sender 22 and receiver 25 partitions, the sender partition 22 updates its own sender read pointer 50 to the value maintained by the receiver 25 when the sender detects a queue overflow. If the overflow condition persists even after using the value of the receiver's read pointer 52, the sender declares an error (receive partition not consuming data). The receiver's read pointer 52 will be advanced at the last stage of the read operation in order to protect the message from being accidentally overwritten. This case happens when the receiver is preempted before completely retrieving the message and the sender becomes short on vacant message entries in the queue. As shown in FIG. 2, the address of the receiver's read pointer 52 is included in the channel registry table 30 (the “Msg Ack” field) and could be referenced by the sender when synchronizing, the values of the two read pointers. The send and receive algorithms are illustrated in FIG. 5, 6 and 7. To prevent the receiver partition 25 from reading an incomplete message due to preemption of the sender partition 22, a dual-state status field is attached to each message indicating whether the message entry is used (valid) or not (empty). If the next entry to be read from the queue contains an empty message, the reader partition concludes that there is no message in the queue. The message status will be made valid only after if it is completely inserted in the queue. A detailed description of the data types and library routines are set forth in Appendix A.

The previously described message-passing protocol fits a client-server model of inter-partition communication. However, this protocol becomes inefficient in case of broadcasting a stream of data to one or multiple partitions since the sender has to insert the message to multiple queues, one for each recipient.

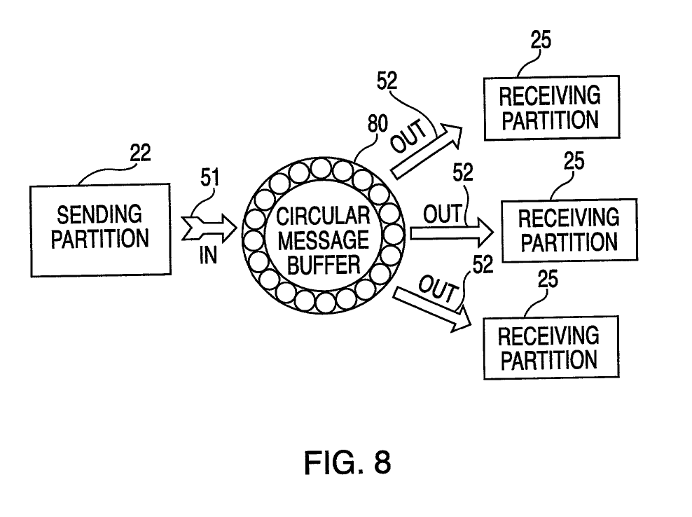

Alternatively a stream buffer of messages could be created by the sender partition in its own memory space and made readable to multiple recipients, as depicted in FIG. 8. The sender will be the only partition that has write permission to the stream buffer 80. The system executive will ensure chat this stream buffer can be written only by the sender and maps the stream buffer 80 to the memory space of one or several recipients as a read-only area.

The stream buffer 80, as shown in FIG. 8, is circular with one write pointer 51 maintained by the sender and a receiver read pointer 52 for each recipient. Each receiver partition 25 is responsible for maintaining its own read pointer. As depicted in FIG. 8, multiple receivers 25 might read from different locations within the circular stream buffer. Since there is only one stream buffer to be used by the sender and all recipients, tight control is needed to correctly handle concurrent read and write requests. Effectively, the sender partition 22 and receiver partition 25 must exclusively lock the message location in the stream buffer before writing or reading a message in order to ensure consistency if the partition is preempted. Locking will not only result in a considerable slowdown of the operation but also might introduce blocking conditions to the sender and recipient partitions.

Alternatively, in accordance with another aspect of our invention we use a more liberal form of concurrency for the control commands, as listed in Appendix B. The stream buffer “IPC_stream” has four attributes:

A ‘message’ field where the message body is stored,

A ‘status’ field indicating whether the message is valid so that a recipient may go ahead and retrieve it,

A message identifier used to distinguish old from recent messages. The identifier is the current value of a per-stream message sequence counter.

A ‘CRC’ check sum code to guard against reading an incompletely updated message.

The sender partition 22, first invalidates the current message, then updates the message body with the proper check sum, sets the message identifier to the current message sequence counter, sets the valid flag and finally increments the message sequence counter. Recipients first make sure that the current message is valid. Next they retrieve the message body and inspect the check sum code. If the recipient is preempted while retrieving a message and the sender inserts a new message in the same location with a new check sum then the recipient will detect that the ‘CRC” does not match the message body it just retrieved and may re-read the message.

The message sequence counter keeps track of the message writing order. Since the stream has multiple readers and a single writer, there might be wide variations in speed and frequency between the writer and one or several of the readers. Thus, the writer might overwrite a message pointed at by a reader. If the reader retrieves two messages after it resumes execution, the reader will end up with out-of-sequence messages since the first message is the most recently inserted one and the second is the oldest message in the stream. By identifying the message order by use of the message sequence counter, the reader partition can detect such an occurrence and can take an appropriate action.

In a manner similar to IPC queues, the stream buffer 80 needs to be statically created in the sender's address space. The sender partition should register the stream buffer 80 with the SE 10 so that the SE 10 includes the address of the stream into the memory map of authorized receiving partitions, with read-only access permission. The SE 10 records the address in a registry table (not shown)(“IPC_stream_registry_table” similar to the “IPC_channel_registry_table” 30 (see FIG. 3) to allow resolution of the stream buffer addresses. Although the “IPC_channel_registry_table” 30 can also be used to register IPC stream buffers, it is better to use a separate table to boost the IPC performance.

The stream registry table (not shown) is maintained by the SE and is made accessible for read-only access to applications. After registration, the receiver partition should query the table for the addresses of the stream data structures. The registration can be performed either during system initialization time, link time or load time. Registering the addresses during system's initialization requires invocation of SE's library routines in order to access the SE's address space. A detailed description of the data types and library routines are set forth in Appendix B.

It is essential for application partitions to know about the failure of other partitions if they are communicating with them. Although it is up to the application partitions to perform necessary recovery procedures in reaction to a failure of a communicating at least the read pointers need to be reset. Since the read pointers can be updated only by the receiving partitions, solutions that make the recovery of a faulty sender partition transparent to the communicating partitions cannot be used.

One possible approach for informing receivers of a failure in a sender partition is to trigger some abnormal IPC condition so that the receiving partitions can detect the failure of the-sender. The system executive can either invalidate the partition IPC area or make it temporarily inaccessible to other partitions. Thus, the other applications could detect an error when communicating with the faulty partition. However, this approach has a fundamental problem that limits its use. The problem surfaces when the recovery and re-initialization of the faulty partition are completed before every receiving partition performs an IPC activity with the faulty partition and experiences the erroneous condition. In this case some receiving partition will not be aware of the sender's failure and will not reset their read pointers. Accordingly, this approach is not feasible.

A second approach, in accordance with another aspect of our invention, is to maintain a health status history for every partition by the system executive 10. The system executive 10 saves the health status of partitions in a shared memory area readable to all partitions writeable solely by the system executive 10. In order for a receiver partition 25 to detect the failure of the sender partition 22, the receiver partition 25 needs to check the status of the sender partition 22 prior to each IPC activity.

The failure history of a partition can be captured by two integer values. The first value indicates the number of repetitions of failure of the sending partition; the second reflects the current status of the partition. Each receiver partition 25 needs to maintain its own copy of a value for the number of times the sender partition 22 has failed. This private value is compared with the value maintained by the system executive (SE) 10 for this particular sender. If the two values match, the sender would be healthy. If the system executive (SE) 10 presents a larger repetition value, the receiver partition 25 would conclude that a failure has occurred in the sender is able to trigger a recovery procedure. Recovery actions include application specific procedures, updating, its own value of the sender's failure repetition to the value presented by the system executive and resetting the read pointer. The second value reflects the status of the partition (ready, being terminated or being initialized). In this way receiver can know the sender is healthy before resuming (or continuing) IPC activities with that sender.

This approach is easy to implement and does not require the SE 10 to participate in the detailed and expensive data movement portions of IPC activities. Since the SE 10 logs errors and monitors partition status, providing senders' status is as simple as making it readable to the receiver partition 25.

Generally, the handling of input and output (I/O) is hardware-dependent. Typically, operating systems abstract an I/O device by a software driver, which manages the device hardware while performing input or output operations. The device driver provides a high-level interface for application tasks that need access to the device. Since I/O devices can be shareable, they can be an indirect means for fault propagation among partitions in our environment. For example, a partition that erroneously keeps on resetting an input device might hinder the device's availability to other healthy partitions and thus disrupt their operation. In addition, the IMA two-layer architecture of FIG. 1 raises multiple issues on how the application will get access to the device.

Typically I/O devices can be classified into two types; polling-based and interrupt-driven devices. In polling-based I/O the device is accessible upon demand and does not notify the application of data availability. Interrupt-driven devices generate an interrupt when the device has completed a previously started operation. The generated interrupt can be handled either by the CPU or by a dedicated device controller. Both types of devices can be either memory-mapped or IO-mapped. In memory-mapped, regular memory-read and write instructions are used to access the device. Special I/O Instructions are used for IO-mapped device access.

In our environment of the present invention, we assume that the CPU will not receive any interrupts from I/O devices. The I/O device should be either polled or supported by a device controller, which is included in the device-specific hardware to handshake with the device and buffer the data. In safety-critical real-time applications such as avionics, frequent interrupts generated by I/O devices to the CPU reduce the system predictability and greatly complicate system validation and certification. In addition, the use of a device controller or I/O co-processor is very common on modem computer architectures to off-load the CPU and boost the performance.

The CPU either supports memory-mapped I/O or provides mechanism to enable partition-level access protection for IO-mapped devices. In all cases, access to I/O devices should not require the use of privileged instructions. In recent years, support of memory-mapped I/O devices has become almost standard on microprocessors. For example, the Motorola® PowerPC processor supports memory-mapped devices only. Using the memory management unit, access to a memory-mapped device can be controlled by restricting the address space of a partition. A partition can access the device using regular memory access instructions if the device address is in its address space. On the other hand, the Intel Pentium processor supports both memory-mapped and I/O mapped devices. However, the I/O instructions of the Pentium processor are privileged. Thus, only memory-mapped devices are allowed if the Pentium processor is used in our environment.

Device handling in our approach can be performed within either the SE 10 or the AE 15. Handling I/O devices within the SE 10 will require the implementation of synchronization mechanisms to maintain correct order of operations among the applications and thus complicate the design of the SE 10. Maintaining the simplicity of the SE 10 is a design goal in order to facilitate the SE 10 certification. In addition, including device handlers in the SE 10 makes the SE 10 sensitive to device changes. Such dependency might mandate the re-certification of the SE 10 every time a new device is added or removed. On the other hand, Application Executives (AEs) cannot handle shared I/O devices without coordination among themselves.

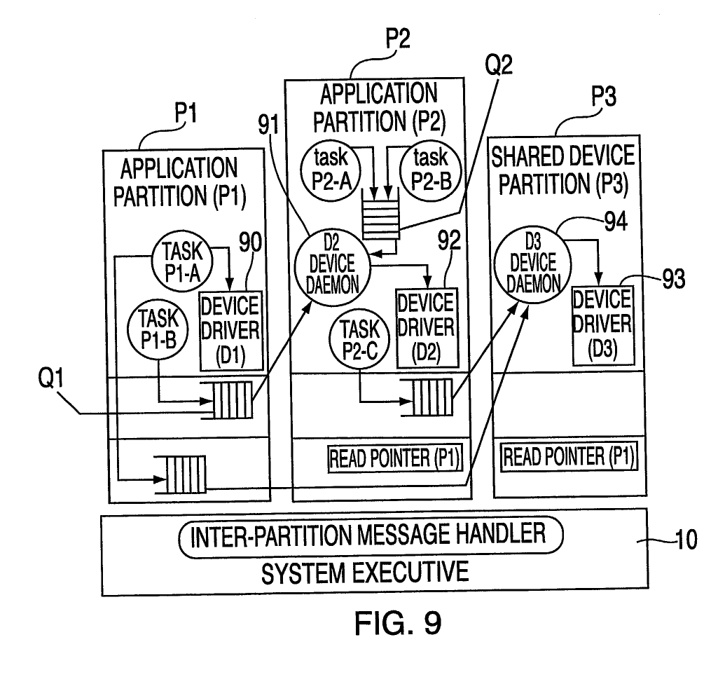

In reference to FIG. 9, in accordance with an aspect of our invention the AE 15 handles I/O devices that are exclusively used by that application (partition). AE 15 synchronization primitives can be used to manage access to a device made by tasks within the partition. The SE 10 will ensure that every device in the system is mapped to one and only one partition. In order to support a shared device among partitions such as a backplane data bus, a device daemon 94 (handler) will be created in a dedicated partition. The device daemon 94 then “serves” access requests to that device driver 93 made by the other application partitions (P1, P2). The shared device manager partition P3 still has exclusive access to the device. Application partitions that need read or write access to a shared device communicate with the device daemon via primitives. Devices that allow read/write (e.g. backplane bus), random read (e.g. a disk) or write-only (e.g. actuator) types of access require the use of client-server IPC protocol for communication among the device daemon 94 and application partitions (P1, P2). In this case, the device daemon 94 serializes requests from different partitions to maintain predictable and synchronized device access patterns. For stream input devices such as sensors, IPC streams (status buffers) can be used by the device daemon 94 to make the input data available to other partitions.

The partition P3 that manages the shared device 93 can perform only device handling or can host an application in addition to processing device access requests. In other words a partition P3, which controls a device, manages access to the device among its own internal asks and can still serve access request from other partitions. For a heavily used shared-device, the dedicated device partition typically contains only the device daemon in order to ensure responsiveness.

Managing a shared device 93 by a partition P3 that hosts other application tasks involves some risk since it introduces dependencies between partitions that require device access and the application partition that hosts the daemon for that device. If a failure of an application task causes the whole partition to crash, the shared device 93 no longer becomes accessible to the other partitions (P1, P2). Since this configuration may threaten the system partitioning, it should not be used unless losing access to the device will not cause other partitions to fail.

Abstracting device access via IPC primitives simplifies the integration of applications through routing messages among applications transparently, whether they are allocated to the same processor or to different processors. The developer consistently refers to applications using IPC channels. An IPC channel, as discussed, can abstract communication with a device or with another application partition. In addition, our approach facilitates the integration of legacy applications designed originally for a federated system since they generally will not require excessive adaptation to use the IPC communications model.

More specifically, an example of the approach of the present invention for device handling is shown in FIG. 9. Two partitions P1 and P2 are integrated in the system. The first partition (P1) needs frequent access to output devices D1 90 and D3 93 and occasional access to the output device D2 92. partition P2 needs heavy access to devices D2 92 and D3 93. In the integrated environment, a dedicated partition P3 is included to manage the shared device D3 93 and to serve requests made by P1 and P2. Partition P3 has an exclusive access to D3 and includes the device daemon 94 task and the device driver 93 for D3. The device driver abstracts the device hardware and can be part of the daemon or as a separate library. Typically, the driver is supplied by the device manufacture. The daemon task receives incoming access requests from other partitions by reading from dedicated request queues (IPC_queue) allocated in a readable shared memory area. Partitions P1 and P2 use the IPC client-server message passing protocol described earlier to communicate with the shared device partition P3.

Partition P1 has an exclusive access to D1, which is not shared with other partitions. Since D2 is shared between P1 and P2, a device daemon is needed. A dedicated partition could have been included to manage D2. Alternatively, D2 was allocated to P2 since P1's access to D2 is significantly less frequent than is P2's. Access requests to D2 from P1 and from tasks within P2 have to be queued for service by the D2 device daemon. As shown in FIG. 9, tasks, P2-A, P2-B, within the partition P2 use a separate queue Q2 to send requests to the device D2 daemon and another queue Q1 is assigned for requests from partition P1. The use of two separate queues decreases the dependencies between partitions P1 and P2.

In the example, it is assumed that only one task per partition needs access to a shared device managed by another partition, e.g. only task P1-B accesses device D2. If multiple tasks per partition need to have access to a shared device among partitions, the AE 15 needs to manage the access order and the priority of requests within the partition. For simplicity, the figure depicts only the device-write scenario. A stream buffer or additional queue will be needed at the shared device partition (e.g, P3) for reading data from the shared device 93.

Device handling in accordance with our invention enables great flexibility in scheduling access requests to the shared device by decreasing the coupling between scheduling of application tasks and shared devices and thus simplifying schedulability analysis. In addition, having the device daemon allocated to a dedicated partition ensures fault containment among the partitions, protects the application partitions from errors in the device driver and facilitates debugging. Again through this approach the SE will have very little to do with I/O handling and will maintain its intended simplicity.

Using the shared device daemon approach, the system integrator needs to schedule the daemon partition as an integral part of the application partitions and to consider it in the schedulability analysis to ensure timeliness under worst-case scenarios. Increased device access requests might mandate invoking the daemon partition for that device at a high frequency to ensure timely access. While the use of a dedicated partition for the device daemon can increase message traffic among partitions, it simplifies the scheduling of the shared device and ensures global consistency of the device status. For example If the daemon partition is preempted during an access to the device.

The present invention is not to be considered limited in scope by the preferred embodiments described in the specification. Additional advantages and modifications, which will readily occur to those skilled in the art from consideration of the specification and practice of the invention, are intended to be within the scope and spirit of following claims.

[image]

[image]

[image]

[image]

[image]

[image]

[image]

[image]

[image]

[image]

[image]

[image]

In the claims:

1. A method for non-corrupt inter-partition application communication between a plurality of partitioned applications operating with the same CPU in an Integrated Modular Avionics (IMA) system, said method comprising the steps of:
executing a system executive module with highest priority and full control of the CPU;
partitioning a plurality of applications to create partitioned applications which each use protected memory space and which operate in a lower priority mode to access the CPU at timed intervals;
allocating outgoing messages generated from each of the plurality of partitioned applications into circular outgoing message queues in shared memory locations allocated for each of the plurality of partitioned applications by the system executive wherein each of the plurality of partitioned application stores the outgoing messages it generates within its allocated shared memory locations;
registering a circular outgoing message queue in a central channel registry table maintained by the system executive application wherein the central channel registry table states an outgoing message address space location in the shared memory locations and lists which of the plurality of partitioned applications are authorized to read each outgoing message;
verifying in a library routine within each of the plurality of partitioned applications that the outgoing messages are properly addressed to the plurality of partitioned applications, and are complete messages, and are not corrupted or addressed to partitioned applications which no longer exist; and
enabling direct reading of the outgoing messages stored within the circular outgoing message queues in the shared memory locations wherein only authorized partitioned applications of the plurality of partitioned applications are permitted to read in read only access from the shared memory.

2. The method of claim 1 for the comprising repeating the above steps for each of the plurality of partitioned applications when run time is allocated by the system executive for each the plurality of partitioned applications.

3. The method of claim 1 further comprising creating a messages read index of the outgoing messages which have been read for each of the plurality of partitioned applications; and
reading the messages read index by the plurality of partitioned applications and determining which messages have been read and which messages can be deleted from the circular outgoing message queues.

4. The method of claim 3 further comprising the steps of:
detecting an overflow of the outgoing circular message queue;
deleting the outgoing messages which have been read to mitigate the overflow of the circular message queue.

5. The method of claim 1 wherein additional new messages are inserted into the outgoing circular message queue.

6. The method of claim 1 wherein the step of registering a circular outgoing message queue includes the step of abstracting the outgoing message queue to a communication primitive format to appear to be a device driver command message when read by the plurality of partitioned applications.

7. The method of claim 6 wherein after the step of abstracting at least one of the outgoing messages is performed, the abstracted outgoing message is read through a communication channel for a device driver in a legacy application to enable the legacy application which can only be accessed through device driver ports to read outgoing messages addressed to the legacy application.

8. The method of claim 1 wherein the circular message queue is arranged as a stream buffer wherein the outgoing messages are in stream format and are thus readable by more than one of the plurality of partitioned applications.

9. The method of claim 1 wherein the system executive maintains a health status history of each of the plurality of partitioned applications which is only writeable by the system executive but which is readable by every application partition.

10. The method of claim 1 wherein devices are included in at least one of the plurality of partitioned applications and said method further comprising the step of controlling the devices using commands in the outgoing messages through a device daemon.

11. The method of claim 1 wherein, during the step of verifying, a dual status field is created and attached to each outgoing message to ensure that each outgoing message is completely stored in the circular outgoing message queues.

12. The method of claim 8 wherein the stream buffer includes additional check codes for verifying data.

13. An aircraft avionics system comprising:
a system executive module which controls a CPU board connected to a data bus;
plurality of partitioned avionic applications partitioned by the system executive to run in a protected memory space allocated for the CPU board according to a time schedule and to create outgoing messages; and
a plurality of circular message queues located in a partitioned shared memory space allocated to the CPU board wherein the circular message queues are only writeable to by an associated one of a plurality of partitioned compliant avionic applications, wherein the circular message queues are directly readable by an associated receiver partitioned avionic application.

14. The system of claim 13 wherein the circular message queues are in a stream buffer format.

15. The system of claim 13 wherein the messages are abstracted to device driver command or data format.

16. The system of claim 15 wherein the messages which are abstracted are read by legacy applications.

17. A method for an aircraft avionics system having a system executive application which controls a CPU board connected to a data bus and which partitions a plurality of partitioned avionic applications, said method comprising the steps of:
executing the plurality of partitioned avionic applications in a protected memory space according to a time schedule to create outgoing messages;
queuing the outgoing messages into a plurality of circular message queues located in a partitioned shared memory space wherein the circular message queues are only writeable to by a sender application from the plurality of partitioned compliant avionic applications; and
reading the outgoing messages in the circular message queues wherein the circular message queues are directly readable by an associated receiver partitioned avionic application.

18. The method of claim 17 wherein the circular message queues are in a stream buffer format.

19. The method of claim 17 further comprising the step of abstracting the messages to a device driver command or data format.
